(19) United States
(12) Patent Application Publication
(10) Pub. No.: US 2006/0243301 A1
(43) Pub. Date: Nov. 2, 2006

(54) System and process for producing clean glass aggregate from recycled glass

(76) Inventors: Shawn J. LeMond, Elizabeth City, NC (US); David R. Lemmond JR., Elizabeth City, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/119,384

(22) Filed: Apr. 29, 2005

(51) Int. Cl. C23G 1/00; B08B 3/00; C03C 23/00

(52) U.S. Cl. 134/2; 134/34; 134/61

(57) ABSTRACT

An apparatus and method for producing clean glass aggregate from recycled glass articles is described. The apparatus includes a crushing device, a screening device, and a specially designed screw washer. The screw washer includes an inclined housing and a rotating auger in the housing. A basin in the lower end of the housing is configured to retain a volume of liquid such as water, such that a lowest end of the auger is submersed in the liquid. At least one inlet is configured to inject a substantially upwardly directed current of liquid into the basin. Crushed and screened glass particles received in the basin are mechanically agitated by the rotating screw auger and are impinged upon by the current of cleaning solution, thereby abrading away and separating contaminants from the glass particles. He auger conveys cleaned glass aggregate from the basin to an exit end of the screw washer.

### FIELD OF THE INVENTION

The invention relates to systems and processes for recycling glass, and more particularly relates, in one embodiment, to an apparatus and process for producing clean glass aggregate from recycled glass articles.

### BACKGROUND

Recycled materials can provide many benefits. Many common household materials, including paper, cardboard, metal cans, glass containers and other glass items can be recycled for use by industry and consumers. The cost of recycling such materials, however, varies depending upon the particular recycled material.

Most industries that use recycled glass require the glass to be substantially free of contaminants. In addition, many industries require glass materials that have a particular composition, color, or purity. Unfortunately, municipal household waste recycling programs generally do not discriminate between glass articles having various colors or compositions. Accordingly, glass items collected by recyclers often include a mixture of different glasses. In addition, collected glass items typically include a substantial amount of contaminants, such as paper and foil labels, bottle caps and lids, food waste, and other non-recyclable refuse that often accompanies recycled glass items into recycling bins.

Recycled container glass, mirror glass, tempered glass, and window glass have significant potential as aggregate in asphalt and concrete, as abrasive media, and as filter media, if the glass aggregate can be effectively cleaned of food residue, label paper and foil, and other non-glass contaminants. Though contaminated glass aggregate may have some value as a substandard filler, significant values can be achieved if the glass can be effectively freed of contaminants.

Contamination presents a substantial obstacle to the use of glass aggregate in asphalt and concrete, as refined abrasives, and as filter media. Paper fibers tend to clog asphalt bag houses when contaminated glass is used as asphalt aggregate. Paper and food residues can clog the nozzles of pneumatic air guns when contaminated glass is used as a sandblasting abrasive. Sugar and oil residue are believed by some to significantly retard and weaken concrete when contaminated glass is used as an aggregate in cement. Furthermore, organic residues and paper fiber contaniments can prevent the use of recycled glass as aggregate as a high end filter media.

Historically, grinding, screening, and cleaning recycled glass has been costly. Prior systems and methods typically have used ball, flail, and/or hammer mills to crush recycled glass articles. Such systems and methods characteristically excessively shred label paper and undesirably incorporate paper fibers into the final glass aggregate product. In order to remove the unwanted paper, label glue, dried sugar, food contaminants, and the like from the crushed glass particles, others have employed expensive fluid bed dryers to bum away the contaminants. Others have employed water cleaning tanks that are substantially ineffective at removing adhered contaminants such as label glue, dried sugars, or coagulated lipids from the glass.

Known systems and methods for producing clean glass aggregate are plagued by high capital costs, high maintenance costs, low throughput, high energy costs, high labor costs, and excessively shredded label paper content. Initial capital costs for a system that produces glass aggregate that is less than one-half inch in size at a rate of 18-20 tons per hour may be as high as $160,000. Such a system may require two employees for operation. The cost of a fluid bed dryer for burning away paper and other contaminants may be as high as about $450,000-$700,000. The cost of an alternative cleaning system such as a water bubble tank may be as high as about $135,000, though such systems are ineffective at removing many types of contaminants. Such systems also typically include on-site bulk storage facilities for storing and staging recycled glass before processing, and various types of glass crushing and screening equipment. The total cost of such known glass recycling systems typically is about $500,000 to about $1,000,000 for a capacity of about 15-20 tons per hour. Energy costs to operate such a glass recycling system may range from about $8 to $16 per ton, depending on present fuel and electricity costs.

As a result of these prohibitively high costs to produce clean glass aggregate, known glass crushing systems predominately have been used to produce recycled glass for use as a low margin filler or substandard additive for asphalt. Due to the resultant underutilization of stockpiled recycled glass since the 1990's, a surplus of recycled glass has accumulated, and recycled glass commodity prices have plummeted.

Accordingly, there is a need for a system and method that cost-effectively transforms recycled glass into clean glass aggregate. More specifically, there is a need for a glass recovery system and method that has substantially lower capital costs than known systems and methods, and is capable of producing clean glass aggregate that includes less than about one percent contaminants by weight. Preferably, such a system should be capable of producing clean glass aggregate that includes not more than about 0.1 percent contaminants by weight. In addition, such a system should be capable of producing glass aggregate of about 0.5 inch or smaller at a rate of about 20 tons per hour or greater.

### SUMMARY

The invention includes an apparatus for removing contaminants from a plurality of particles. The apparatus includes a basin for receiving the plurality of particles. The basin is configured to retain a volume of liquid. The apparatus further includes a rotating auger in the basin for mechanically agitating the plurality of particles in the basin. The apparatus also includes at least one inlet configured to direct a current of the liquid onto at least a portion of the plurality of particles as the particles are mechanically agitated in the basin.

The invention also includes an apparatus for producing clean glass aggregate from glass particles that include at least one contaminant. The apparatus includes an inclined housing having a lower end and an upper end. An auger having a first end and a second end is rotatably mounted in the housing, and substantially extends between the lower end and the upper end of the housing. A basin in the lower end of the housing is configured to retain a volume of cleaning solution, such that the first end of the auger is at least partially submersed in the volume of cleaning solution. The apparatus further includes at least one inlet configured to inject a substantially upwardly directed current of cleaning solution into the basin. Crushed glass particles received in the basin are mechanically agitated by the rotating screw auger and are impinged upon by the current of cleaning solution, thereby separating at least a portion of the contaminant from the glass particles. Cleaned glass particles are transferred to the upper end of the housing by the rotating auger.

The invention also includes a method of removing a contaminant from crushed glass particles. The method includes mechanically agitating the glass particles in a volume of liquid, and simultaneously directing at least one substantially upward stream of the liquid onto a portion of the particles.

These and other aspects of the invention will be understood from a reading of the following detailed description together with the drawings.

### BRIEF DESCRIPTION OF THE DRAWINGS

FIGS. 1a and 1b are a schematic diagram showing one embodiment of a recycled glass recovery system according to the invention.

FIG. 2 is a flow chart showing one embodiment of a recycled glass recovery process according to the invention.

FIG. 3 is an elevation of one embodiment of a crushing apparatus for use in the recycled glass recovery system shown in FIGS. 1a and 1b.

FIG. 4 is an elevation view of one embodiment of a vibratory screening device for use in the recycled glass recovery system shown in FIGS. 1a and 1b.

FIG. 5 is an elevation view of an inclined screw washer for use in the recycled glass recovery system shown in FIGS. 1a and 1b.

FIG. 6 is a top plan view the inclined screw washer shown in FIG. 5.

### DETAILED DESCRIPTION

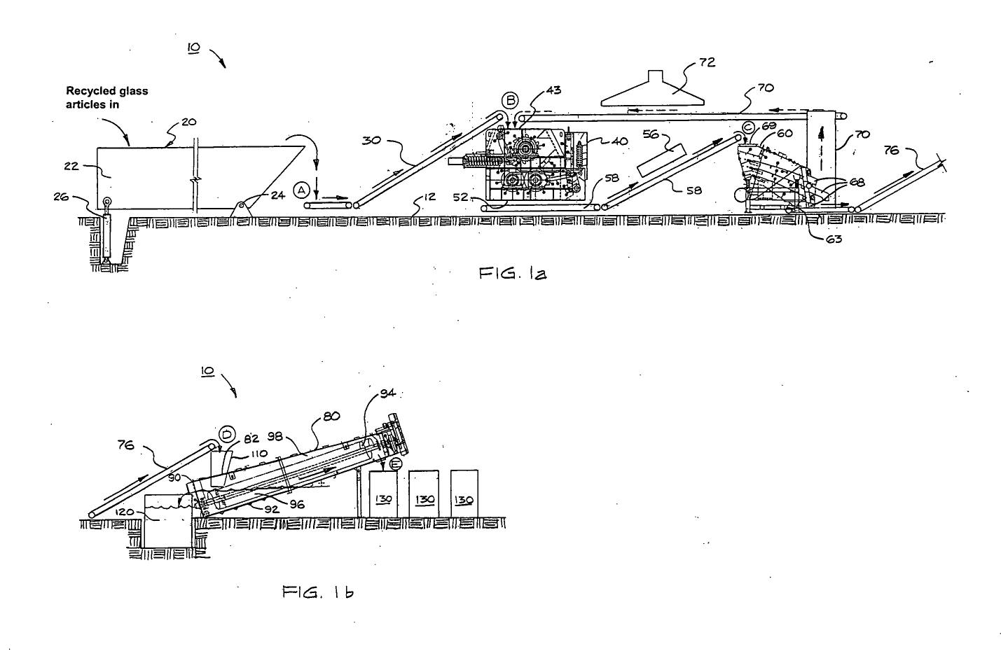

One embodiment of a crushing apparatus 10 for recovering recycled glass according to the invention is shown in FIGS. 1a and 1b. The system 10 includes an input hopper 20. The hopper 20 may include a container 22 that is pivotably mounted to a foundation 12 by a pinned connection 24. One or more hydraulic pistons 26 actuate the hopper 20 between a fully lowered or stowed position and a fully raised or delivery position. The hopper 20 may be configured to be tilted at an angle of about 20-45 degrees from horizontal in the fully raised delivery position. In one embodiment, the container 22 is about 20-25 feet wide, about 30-40 feet long, and about 4-6 feet tall. The container 22 has a substantially open top to permit recycled glass articles to be directly transferred from a delivery truck to the hopper 20. Preferably, the hopper 20 is configured to receive, retain, and feed up to about 20 tons of recycled glass articles. The large tiltable hopper 20 permits direct delivery of recycled glass materials to the system 10, and substantially eliminates the need for separate on-site storage or staging facilities.

When the hopper 20 is in the fully raised delivery position, glass articles are transferred from the hopper 20 to an intake conveyor belt 30 at point “A” in FIG. 1a. In one embodiment, the intake conveyor 30 is cleated and is about 30-40 inches wide. Preferably, the intake conveyor has opposed sidewalls that are about 10 to 18 inches tall to retain the glass articles on the belt 30. Operation of the intake conveyor 30 may be selectively controlled by a foot pedal or the like to permit a system operator to temporarily stop the intake conveyor 30 to remove any undesirable foreign objects from the stream of recycled glass articles on the belt 30. The intake conveyor 30 delivers a stream of recycled glass articles to a crushing unit 40 at point “B” in FIG. 1a.

In one embodiment, the crushing unit 40 is a triple roll crusher 41 like that shown in FIG. 3. In this embodiment, the triple roll crusher 41 includes a housing 50 with a feed opening 43 in its top, and a discharge opening 52 in its bottom. Recycled glass articles exit the intake conveyor 30 and enter the crusher 41 through the feed opening 43. As the glass articles fall through the feed opening 52, the articles encounter a rapidly rotating primary roller 42. The primary roller 42 may operate at speeds of about 50 rpm or greater, and may include a plurality of spaced teeth 49 having varying lengths of about 1-3 inches. The glass articles are directed between the primary roller 42 and a substantially stationary crushing plate 44. Preferably, a feedstock clearance of about one inch or less is provided between the primary roller 42 and the crushing plate 44. The rotating teeth 49 on the primary roller 42 impact the glass articles at a high velocity, and thereby shatter the glass articles into glass shards.

The glass shards are directed from the primary roller 42 to a passive secondary roller 46 and an opposed powered secondary roller 48. The triple roll crusher 41 may include a 35 horsepower electric motor or a larger motor to drive the primary roller 42 and the powered secondary roller 48. The opposed secondary rollers 46, 48 may cooperatively rotate at about 300 rpm or greater. The outer surfaces 57 of the secondary rollers 46, 48 may each include a plurality of cooperating spaced teeth that are about 0.25 inches or shorter in length. The spacing between the secondary rollers 46, 48 may be selectively adjusted to produce a desired size of glass aggregate. As the glass shards pass between the oppositely rotating secondary rollers 46, 48, the shards are compressively crushed into smaller glass particles. A triple roll crusher 41 suitable for use in the system 10 has been specially produced for the applicant by McLanahan Corp. of Hollidaysburg, Pa. As shown in FIG. 1a, the glass particles exit the crusher 40 through the discharge opening 52, and are deposited onto a second conveyor 58.

The second conveyor 58 carries the glass particles from the crusher 40 to a screening or sizing device 60 at point “C” in FIG. 1a. A magnet 56 may be provided proximate to the conveyor 58 to remove ferritic contaminants from the glass particles. The magnet 56 may be a cross belt magnetic separation unit, for example, or any other suitable magnetic separation device. Alternatively, the glass particles may be fed directly from the crushing device 40 to the screening device 60.

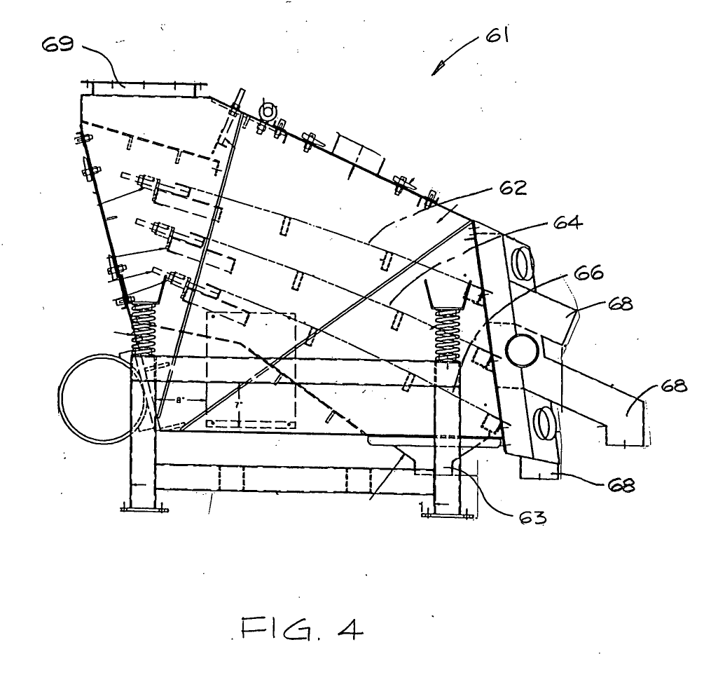

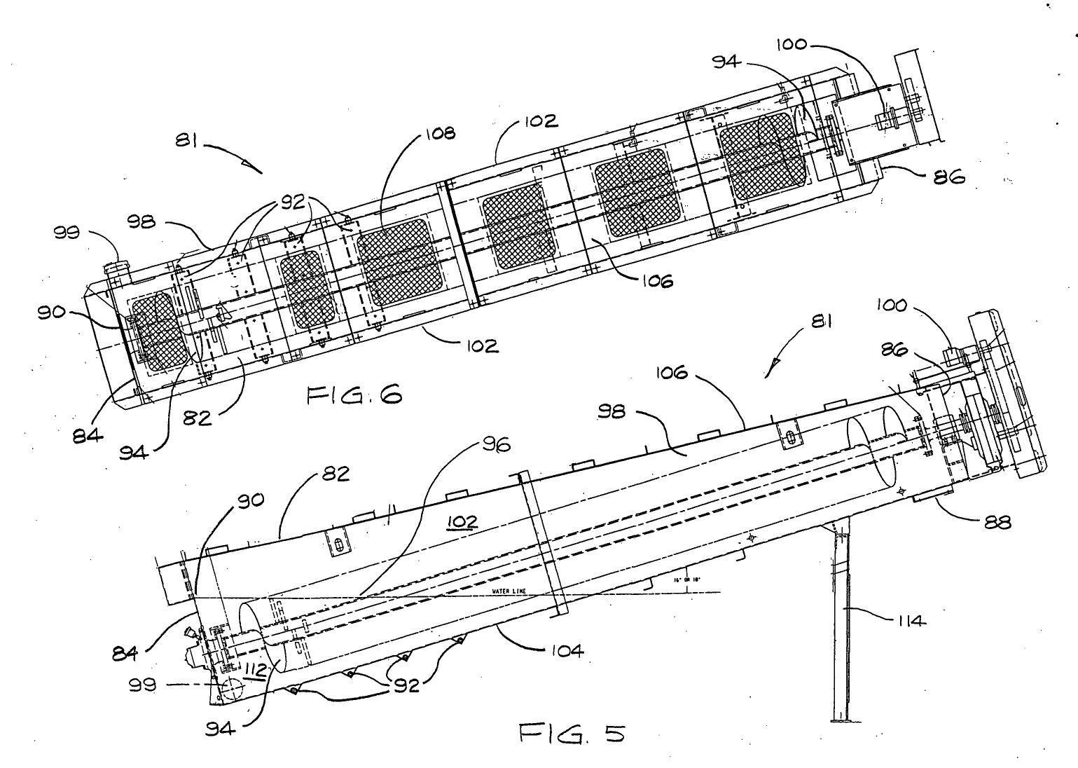

In one embodiment, the screening device 60 is a multi-deck vibratory screener 61 like that shown in FIG. 4. The glass particles enter the vibratory screener 61 through a feed opening 69, and are directed to a first stage screen 62. The first stage screen 62 may include a mesh of about 0.4 inch diameter wire having 3 inch square openings, for example. Glass particles and objects that are smaller than openings in the first stage screen 62 pass to a second stage screen 64. The second stage screen 64 may include a mesh of about 0.1 inch diameter wire having about 0.4 inch square openings, for example. Glass particles and objects that are smaller than openings in the second stage screen 64 pass to a third stage screen 66. The third stage screen 66 may include a mesh of about 0.1 inch diameter wire having about 0.25 inch square openings, for example. Glass particles and objects that are smaller than openings in the third stage screen 66 are directed to a discharge chute 63. Glass shards and objects that are too large to pass through any of the screens 62, 64, 66 are directed to a plurality of outlets 68. As indicated by the dashed arrows in FIG. 1a, one or more return conveyors 70 may be used to return at least a portion of the separated large glass shards and large objects to the crusher 40 for further processing. For example, large objects screened by the first stage screen 62 may be discarded, and objects screened by the second and third stage screens 64, 66 may be returned to the crushing device 40. A vacuum system 70 may be provided proximate to the return conveyor 70 to extract light objects such as loose paper and dust from returned glass shards and objects before they are reintroduced into the crusher 40. The vacuum 70 is effective to remove paper labels and the like from the returned materials. A multi-deck vibratory screener 61 suitable for use in the system 10 is model no. E-0536 by McLanahan Corp. of Hollidaysburg, Pa.

As shown in FIGS. 1a and 1b, the system 10 may include a third conveyor 76 to transfer the output of small glass particles from the screener 40 to a screw washer 80 at point “D”. One embodiment of a screw washer 81 for use in the glass crushing and recovery system 10 is shown in FIGS. 5 and 6. In this embodiment, the screw washer 81 includes an inclined, elongated housing 98 having a lower end 84, an upper end 86, a bottom 104, a pair of opposed sidewalls 102, and a top 106. A support 114 maintains the upper end 86 of the housing 98 at an elevated position. In the embodiment shown, the housing 98 is about 240 inches long, and is inclined at an angle of about 18 degrees from horizontal. As shown in FIGS. 5 and 6, the top 106 of the housing 98 includes a feed opening 82 proximate to the lower end 84 for receiving a flow of glass particles, and may include a plurality of windows or openings 108 along its length. A discharge opening 88 is provided in the bottom 104 of the housing 98 proximate to the upper end 86. As shown in FIG. 5, the lower end 84, bottom 104, and sidewalls 102 of the housing 98 define a basin 112 that retains a volume of water 96 in a lower portion of the housing 98. Water or another suitable liquid is supplied to the basin 112 through a supply inlet 99. An adjustable weir 90 is provided at the lower end 84 of the housing 98 to maintain a desired level of water 96 in the housing 98, and to permit floating materials to be skimmed from the surface of the water 96. One or more up-current water inlets 92 are provided proximate to the bottom 104 and lower end 84 of the housing 98. The inlets 92 are configured to inject jets, currents, or streams of water or another cleaning solution into the basin 112 in a substantially upward direction.

A screw auger 94 is rotatably mounted in the housing 98 such that a lower end of the auger 94 is substantially submersed in the volume of water 96 in the basin 112. In one embodiment, the auger has a diameter of about 20 inches or greater, and is spaced from the bottom 104 and sidewalls 102 of the housing 98 by a gap of about 2 inches or more. A motor 100 causes the auger 94 to rotate in the housing 98. In one embodiment, the motor 100 is rated at about 10 horsepower or higher. A screw washer 81 that is suitable for use in the system 10 has been specially produced for the applicant by McLanahan Corp. of Hollidaysburg, Pa.

In operation, a mixture of glass particles and various contaminants is introduced into the screw washer 80 through the feed opening 82. As shown in FIG. 1b, the glass particles may be introduced into the basin 112 of the screw washer at or below the top surface of the water 96 by a feed chute 110. The rotating auger 94 mechanically agitates the glass particles in the water 96 within the basin 112, thereby causing adjacent glass particles to vigorously rub against one another. This vigorous rubbing between glass particles acts abrade away adhered contaminants such as glue, dried foods, or the like, thereby causing the contaminants to be separated from the glass particles. Because such contaminants are less dense than the surrounding water 96, these separated contaminants tend to float to the top of the water 96, unless the contaminants become entrapped among the heavier glass particles. The substantially upwardly directed jets, currents, or streams of water supplied from the inlets 92 at the bottom of the basin 112 impinge upon the mixture of glass particles and loosened contaminants as the mixture is mechanically agitated by the rotating auger 94, thereby freeing the loosened contaminants from the glass particles, and permitting the contaminants to float to the top surface of the water 96. The floated contaminants are then skimmed from the surface of the water 96 by the weir 90. As shown in FIG. 1b, the skimmed water and contaminants may be passed to a clarifying tank 120 for separation of the contaminants from the water 96. In one embodiment, the clarifying tank 120 has a capacity of about 500 gallons or more. Clarified water may be reintroduced into the screw washer 80 from the clarifying tank 120 through the supply inlet 99 and/or nozzles 92.

Accordingly, the combination of the mechanical abrasive action of the rotating screw auger 94 and the impinging water jets, currents, or streams from the inlets 92 effectively separates adhered contaminants from the glass particles. Once thus cleaned, the glass particles are carried upward in the housing 98 by the rotating auger 94. Once the particles are carried out of the water 96 in the basin 112 by the auger 94, the continued agitation of the particles by the auger 94 facilitates air drying of the particles as they approach the upper end 86 of the housing 98. The dried glass particles or cleaned glass aggregate exits the screw washer 81 through the discharge opening 88. As shown in FIG. 1b, the cleaned glass aggregate may collected in a collection bin or drum 130 as the aggregate exits the screw washer 80 at point “E”.

The system 10 described above has been demonstrated to produce glass aggregate of a size less than 0.5 inch, and having less than about one percent contaminants by weight. In addition, the system 10 has been demonstrated to produce clean glass aggregate containing less than about 0.1 percent contaminants by weight. Such clean glass aggregate is desirable for use in many applications, such as aggregate for use in asphalt and cement, as an abrasive suitable for use in sandblasting operations, and as filter media. In addition, a system like that shown in FIGS. 1a and 1b and described above has been shown to operate at 20-40 tons per hour, has a capital cost that is about half that of known recycled glass recovery systems, has low annual maintenance costs compared to known systems, and utilizes electricity at a rate of less than about three dollars per ton.

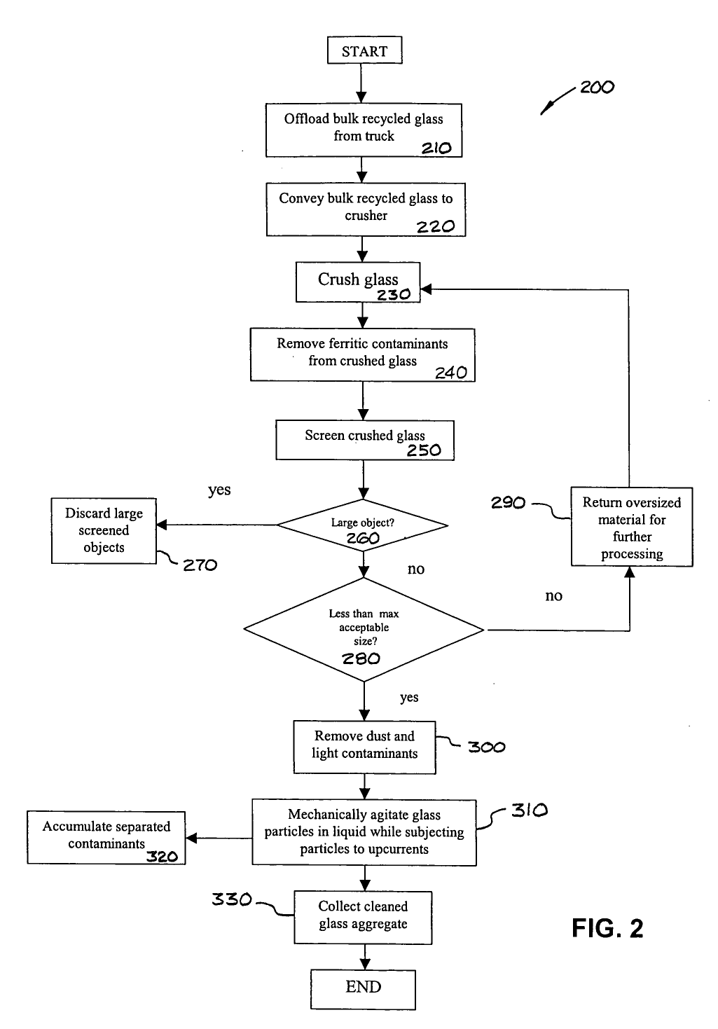

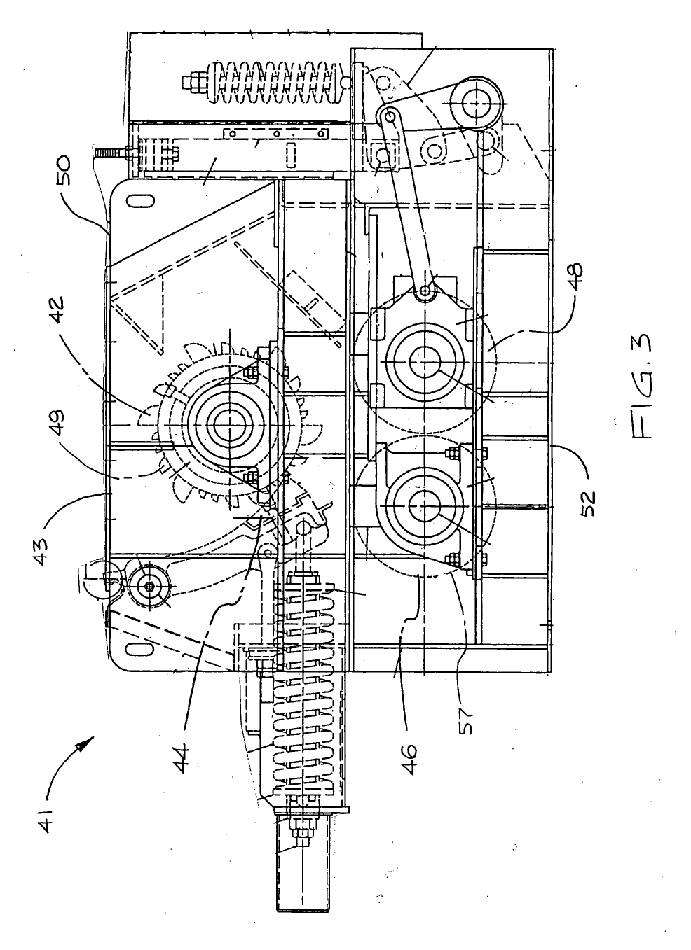

As shown in FIG. 2, the invention also includes a method 200 of producing clean glass aggregate from recycled glass articles. In this method 200, bulk recycled glass is offloaded 210 from a transport truck. The bulk recycled glass is conveyed 220 to a suitable crushing device. In one embodiment, the bulk recycled glass is conveyed 220 to a triple roll crusher, or other comparable compressive crushing device. The glass is initially crushed 230 into shards, and ferritic contaminants are separated 240 from the crushed glass, such as by a magnetic separator. The crushed glass is then screened 250 to extract excessively large glass shards and foreign objects from the mass of crushed glass. If a screened item is determined 260 to be a large foreign object, the item may be discarded 270. Alternatively, if a screened item is determined 260 to be other than a large foreign object, the object may be processed. If a screened glass shard or particle is determined 280 to be larger than a maximum desired size, the material is returned for further crushing 230. Otherwise, the acceptably sized glass material is vacuumed 300 to remove light contaminants and dust. The crushed glass is then agitated 310 in water or another suitable liquid bath to separate and remove adhered contaminants. Preferably, the crushed glass is subjected 310 to substantially upward jets, streams, or currents of water or other liquid as the glass particles are simultaneously mechanically agitated. Separated contaminants may be accumulated 320 in a clarifying tank, and the cleaned glass aggregate can then be collected 330 for packaging and/or transport.

The above descriptions of various embodiments of the invention are intended to describe and illustrate various aspects of the invention, and are not intended to limit the invention thereto. Persons of ordinary skill in the art will understand that various modifications may be made to the described embodiments without departing from the invention. All such modifications are intended to be within the scope of the appended claims.

What is claimed is:

1. An apparatus for removing contaminants from a plurality of particles, the apparatus comprising:
a) a basin for receiving the plurality of particles, the basin being configured to retain a volume of liquid;
b) a rotating auger in the basin for mechanically agitating the plurality of particles in the basin; and
c) at least one inlet in the basin configured to direct a current of the liquid onto at least a portion of the plurality of particles as the particles are mechanically agitated in the basin.

2. An apparatus according to claim 1 further comprising a weir for skimming contaminants from the basin.

3. An apparatus according to claim 2 further comprising a clarifying tank for receiving skimmed contaminants from the weir.

4. An apparatus according to claim 1 further comprising a vacuum for removing a plurality of fine particulates from the plurality of particles.

5. An apparatus according to claim 1 further comprising a magnet for extracting ferritic materials from the plurality of particles.

6. An apparatus according to claim 1 further comprising a roll crusher for producing the plurality of particles from a quantity of a glass articles.

7. An apparatus according to claim 1 further comprising a screening device for separating objects larger than the particles from the plurality of particles.

8. An apparatus for producing clean glass aggregate from glass particles that include at least one contaminant, the apparatus comprising:
a) an inclined housing having a lower end and an upper end;
b) an auger having a first end and a second end, the auger being rotatably mounted in the housing, and substantially extending between the lower end and the upper end of the housing;
c) a basin in the lower end of the housing configured to retain a volume of liquid such that the first end of the auger is at least partially submersed in the volume of liquid; and
d) at least one inlet configured to inject a substantially upwardly directed current of cleaning solution into the basin;
e) wherein crushed glass particles received in the basin are mechanically agitated by the rotating screw auger, and are impinged upon by the current of liquid, thereby separating at least a portion of the contaminant from the glass particles; and
f) wherein cleaned glass particles are transferred to the upper end of the housing by the rotating auger.

9. An apparatus according to claim 8 further comprising a weir for skimming contaminants from the basin.

10. An apparatus according to claim 9 further comprising a clarifying tank for receiving skimmed contaminants from the weir.

11. An apparatus according to claim 8 further comprising a vacuum for removing a plurality of fine particulates from the glass particles.

12. An apparatus according to claim 8 further comprising a magnet for separating ferritic materials from the glass particles.

13. An apparatus according to claim 8 further comprising a roll crusher for producing the glass particles from a quantity of a brittle material.

14. An apparatus according to claim 8 further comprising a screening device for separating objects and glass shards larger than a desired maximum size of glass particles from the glass particles.

15. A method of removing a contaminant from crushed glass particles, the method comprising:
a) mechanically agitating the glass particles in a volume of liquid; and
b) simultaneously directing at least one substantially upward stream of the liquid onto a portion of the particles.

16. The method of claim 15 further comprising skimming at least some separated contaminants from the volume of liquid.

17. The method of claim 15 further comprising removing fine particulates from the glass particles prior to agitation.

18. The method of claim 15 further comprising screening large objects from the glass particles prior to agitation.

19. The method of claim 15 further comprising separating ferritic materials from the glass particles prior to agitation.

20. The method of claim 15 further comprising drying the glass particles after agitation in the volume of liquid.
